(19) United States
(12) Patent Application Publication
(10) Pub. No.: US 2009/0271320 A1
(43) Pub. Date: Oct. 29, 2009

(54) SYSTEM FOR ELECTRONIC BUSINESS TRANSACTIONS

(76) Inventors: Kwan-sik Kang, Anyang-si (KR); Ki-Soo Kim, Seoul (KR)

Correspondence Address: HAMRE, SCHUMANN, MUELLER & LARSON, P.C., P.O. BOX 2902, MINNEAPOLIS, MN, 55402-0902, US

(21) Appl. No.: 12/441,421

(22) PCT Filed: Sep. 20, 2007
(86) PCT No.: PCT/KR2007/004571

§ 371 Date: Mar. 16, 2009

(30) Foreign Application Priority Data
Sep. 22, 2006 (KR) 10-2006-0092270

(51) Int. Cl. G06Q 30/00; G06Q 20/00

(52) U.S. Cl. 705/64; 705/40; 705/17

(57) ABSTRACT

An electronic business transaction system is provided. The electronic business transaction system requests an ordering party to select an electronic business and input order information for the electronic business through a terminal of the ordering party, receives the order information for the electronic business from the ordering party, announces a bid for the electronic business, requests bidders to select the electronic business, input bid information for the electronic business, and organize execution groups for the electronic business through a terminal of the bidders, receives the bid information and information for the execution groups from the bidders, analyzes the bid information and the information for the execution groups, selects an order-taking party from among the bidders according to the results of the analysis, concludes an electronic contract for the electronic business between the order-taking party and the ordering party, and provides an application for processing the electronic business regarding the electronic contract to terminals of execution group members belonging to an execution group of the order-taking party so that the execution group members process the electronic business through the terminals of the execution group

### TECHNICAL FIELD

The present invention relates to an electronic business transaction system, and more particularly, to a system for electronic business transactions between an ordering party and an order-taking party.

### BACKGROUND ART

With development of information technologies, the industrial society's transition into information society has been carried out with digitalizing and networking of various information. With this trend, employment markets are also changing, and the traditional types and customs of labor are also rapidly changing into business types which can be managed through information communications devices. Due to the changes of employment paradigms, an electronic market has been established in which a predetermined business is conducted without any restrictions in space and time and labor is treated as electronic goods to be transacted freely in the form of an electronic business on the Internet.

A conventional electronic recruiting technology, which introduces ordering parties and potential order-taking parties to each other, is nothing more than a technology of searching for jobs at accessible workplaces. In the conventional electronic recruiting technology, the actual recruiting activities have been conducted in an off-line environment. Meanwhile, an electronic bidding technology by which an enterprise selects a successful bidder through bidding, and an electronic-procurement technology which procures goods for enterprises also have been developed.

However, in the conventional technologies, only a bid announcement, a bid, and selection of a successful bidder have been conducted in an on-line environment, and practical businesses have been performed in an off-line environment.

Accordingly, the present inventor proposes an electronic business transaction system which defines businesses (hereinafter, referred to as electronic businesses) which can be electronically processed, standardizes a procedure of each electronic business according to the type of the electronic business, and transacts the standardized electronic business in an on-line environment by organizing an execution group for the electronic business, drawing up an electronic contract for the electronic business, and distributing the electronic business to members belonging to the execution group in an on-line environment so that the members process the electronic business. Therefore, it is possible to assign a value to labor and transact the labor as a type of electronic goods.

### DISCLOSURE OF INVENTION

### Technical Problem

The present invention provides an electronic business transaction system which standardizes an electronic business, and transacts the standardized electronic business in an on-line environment by organizing an execution group, drawing up an electronic contract for the electronic business, and distributing the electronic business to members belonging to the execution group in the on-line environment so that the members process the electronic business.

### Technical Solution

According to an aspect of the present invention, there is provided an electronic business transaction system including: an electronic business defining unit defining a plurality of electronic businesses, categorizing the electronic businesses according to types or fields of the electronic businesses, standardizing a procedure of each electronic business, and storing the procedure of the each electronic business; an order information input unit providing a list of the electronic businesses, requesting an ordering party to select an electronic business from among the electronic businesses and input order information for the electronic business through a terminal of the ordering party; an electronic business bid announcement unit announcing a bid for the electronic business; a bid information input unit requesting bidders for the electronic business to select the electronic business, and input bid information for the electronic business, and execution groups organized to execute the electronic business, through terminals of the bidders; an order-taking party selecting unit analyzing the bid information for the electronic business and information for the execution groups of the bidders that are input through the bid information input unit, and selecting an order-taking party from the bidders according to the result of the analysis; an electronic contract concluding unit concluding an electronic contract for the electronic business between the ordering party and the order-taking party, and encrypting and storing an electronic contract document for the electronic contract; an electronic business processing unit providing an application for processing the electronic business to terminals of execution group members belonging to an execution group of the order-taking party, and allowing the terminals of the execution group members to process the electronic business; and a payment processing unit paying for the electronic business regarding the electronic contract.

Additional features of the invention will be set forth in the description which follows, and in part will be apparent from the description, or may be learned by practice of the invention.

### ADVANTAGEOUS EFFECTS

The electronic business transaction system according to the present invention standardizes an electronic business, transacts the standardized electronic business in an on-line environment, organizes an execution group, draws up an electronic contract for the electronic business, and distributes the electronic business to members belonging to the execution group in the on-line environment for them to process the electronic business. Therefore, it is possible to assign a value to labor and transact the labor as a type of electronic goods, thereby providing enhanced user convenience for electronic business transactions.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of an electronic business transaction system according to an embodiment of the present invention;

FIG. 2 illustrates an example of a user interface through which a user inputs order information;

FIG. 3 illustrates an example of a bid announcement screen for an electronic business;

FIG. 4 illustrates an example of a user interface through which a user inputs bid information;

FIG. 5 illustrates an example of a user interface through which a user organizes an execution group for an electronic business;

FIG. 6 illustrates an example of a screen showing a selected order-taking party;

FIG. 7 illustrates an example of a user interface through which a user draws up an electronic contract;

FIG. 8 illustrates an example of an electronic contract document; and

FIG. 9 is a flowchart of an electronic business transaction method according to an embodiment of the present invention which is performed by the electronic business transaction system illustrated in FIG. 1.

### BEST MODE FOR CARRYING OUT THE INVENTION

According to an aspect of the present invention, there is provided an electronic business transaction system including: an electronic business defining unit defining a plurality of electronic businesses, categorizing the electronic businesses according to types or fields of the electronic businesses, standardizing a procedure of each electronic business, and storing the procedure of the each electronic business; an order information input unit providing a list of the electronic businesses, requesting an ordering party to select an electronic business from among the electronic businesses and input order information for the electronic business through a terminal of the ordering party; an electronic business bid announcement unit announcing a bid for the electronic business; a bid information input unit requesting bidders for the electronic business to select the electronic business, and input bid information for the electronic business, and execution groups organized to execute the electronic business, through terminals of the bidders; an order-taking party selecting unit analyzing the bid information for the electronic business and information for the execution groups of the bidders that are input through the bid information input unit, and selecting an order-taking party from the bidders according to the result of the analysis; an electronic contract concluding unit concluding an electronic contract for the electronic business between the ordering party and the order-taking party, and encrypting and storing an electronic contract document for the electronic contract; an electronic business processing unit providing an application for processing the electronic business to terminals of execution group members belonging to an execution group of the order-taking party, and allowing the terminals of the execution group members to process the electronic business; and a payment processing unit paying for the electronic business regarding the electronic contract.

It is to be understood that both the foregoing general description and the following detailed description are exemplary and explanatory and are intended to provide further explanation of the invention as claimed.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In the specification, the term “electronic business” means electronic data which is used for accounts, document preparation, program development, web design, translation, etc., can be electronically processed through a personal computer, etc., and can be received or transmitted through a network. Meanwhile, the term “ordering party” means a party who provides an electronic business, the term “order-taking party” means a party which accepts an electronic business and manages members (hereinafter, referred to as members of an execution group) who execute the electronic business, and the term “recruiter” means a party who recommends the members of the execution group.

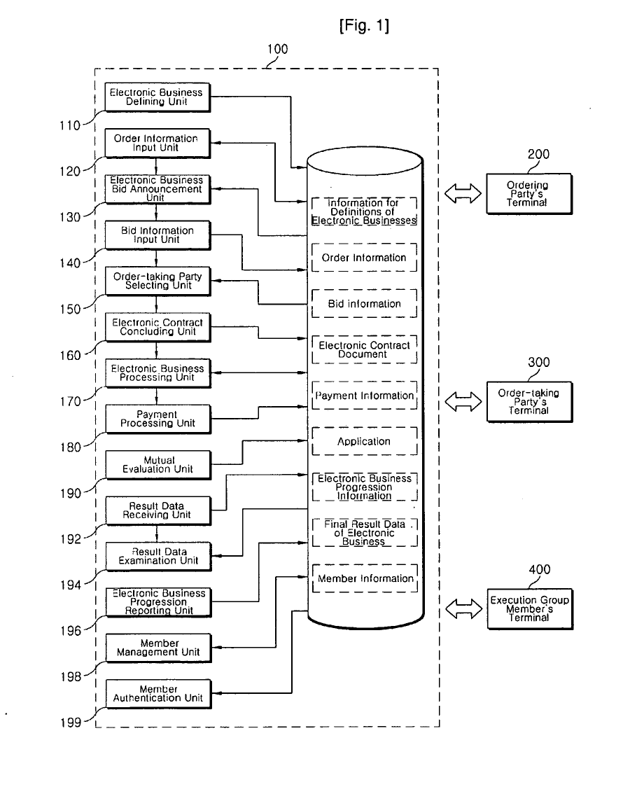

FIG. 1 is a block diagram of an electronic business transaction system 100 according to an embodiment of the present invention. Referring to FIG. 1, the electronic business transaction system 100 includes an electronic business defining unit 110, an order information input unit 120, an electronic business bid announcement unit 130, a bid information input unit 140, an order-taking party selecting unit 150, an electronic contract concluding unit 160, an electronic business processing unit 170, and a payment processing unit 180.

The electronic business defining unit 110 defines electronic businesses, categorizes the electronic businesses according to the types or fields of the electronic businesses, and standardizes and stores a procedure of each electronic business. In order to assign a value to an electronic business and transact the electronic business as a type of electronic goods in an on-line environment, it is needed to define the electronic businesses, standardize the procedures of the electronic businesses, and store the standardized electronic businesses in a database. The electronic business transaction system 100 provides a user interface (UI) through which a system manager defines electronic businesses, defines the electronic businesses through the user interface, categorizes the electronic businesses according to the types or fields of the electronic businesses, standardizes the procedures of the electronic businesses, and then stores the electronic businesses in a database. An electronic business which is defined through the user interface may be accounts. If accounts are defined as an electronic business item, a procedure required for accounts is defined. A definition of an electronic business and standardization of a procedure of the electronic business are under the control of the system manager, and accordingly, a detailed description thereof will be omitted.

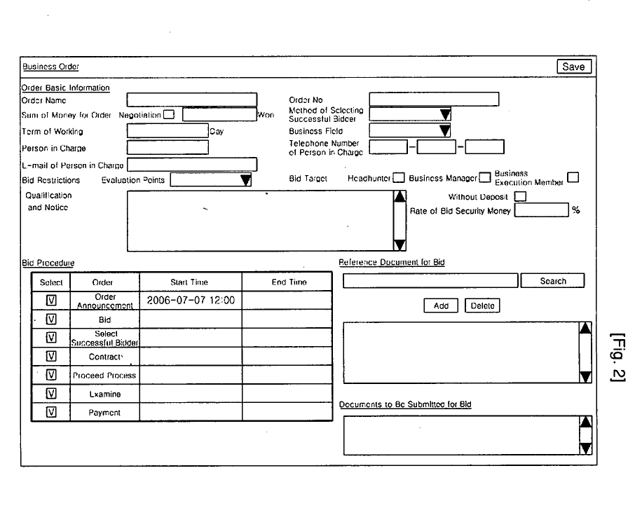

The order information input unit 120 provides a list of the electronic businesses defined by the electronic business defining unit 110, requests an ordering party to select an electronic business from the electronic businesses and input order information for the electronic business through the ordering party's terminal 200, and then receives the order information for the electronic business from the ordering party. In detail, the electronic business transaction system 100 provides a list of electronic businesses to the ordering party's terminal 200 according to the ordering party's request, allows the ordering party to inspect the list of electronic businesses, provides, if the ordering party selects an electronic business from among the list of electronic businesses, a user interface for the ordering party to input order information for the electronic business, and receives the order information for the electronic business through the user interface. FIG. 2 illustrates an example of a user interface through which a user inputs order information for an electronic business, wherein the user interface is provided by the order information input unit 120. Referring to FIG. 2, the user interface includes a part to which data such as an order number is automatically input, and a part to which data such as a sum of money is manually input by an ordering party. An item that is to be input depends on the types of electronic businesses.

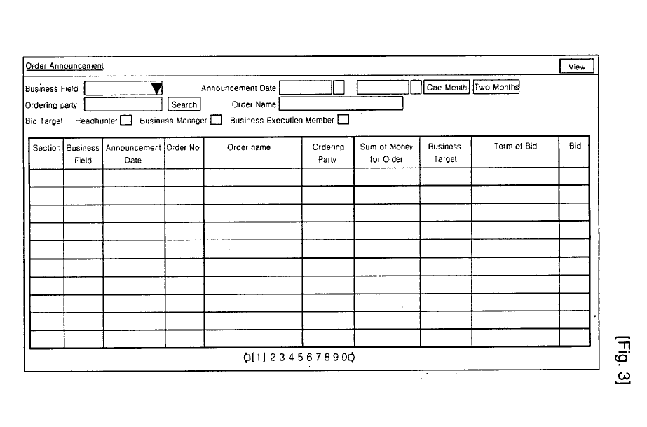

Referring to FIGS. 1 and 2, the electronic business bid announcement unit 130 announces a bid for the electronic business whose order information is input by the order information input unit 120. If order information for the electronic business is input by the order information input unit 120, the electronic business transaction system 100 verifies the truth of the order information, and announces a bid for the electronic business based on the order information if the order information is true. Bidders who want to enter a bid for the electronic business access the electronic business transaction system 100 through the bidders' terminals 300, and look into a bid announcement for the electronic business. For example, the truth of the order information can depend on a grade of the corresponding ordering party, which will be described later. FIG. 3 illustrates an example of a bid announcement screen for the electronic business which is announced by the electronic business bid announcement unit 130.

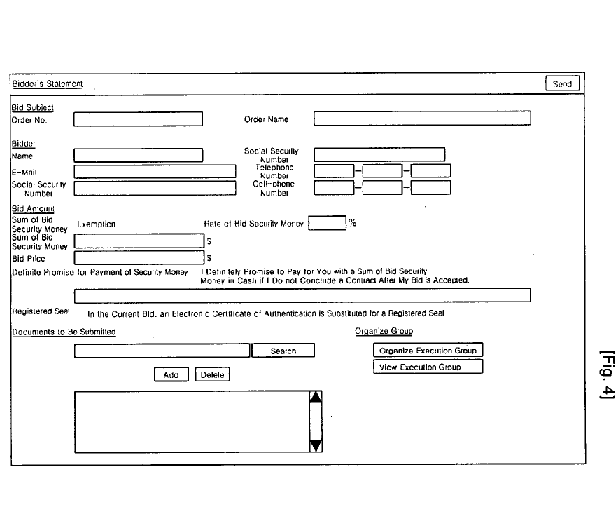

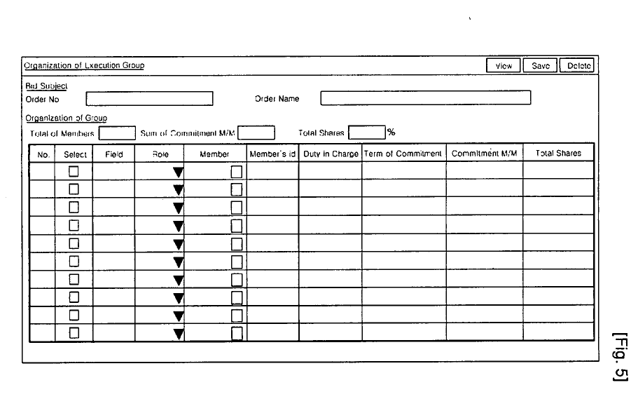

Referring to FIGS. 1 and 3, the bid information input unit 140 requests a bidder to input bid information for the electronic business announced by the electronic business bid announcement unit 130, and organize an execution group for the electronic business, through the bidder's terminal, and then receives the bid information and information regarding the execution group from the bidder's terminal. In detail, if a bid for the electronic business is announced by the electronic business bid announcement unit 130, a bidder who wants to enter the bid for the electronic business accesses the electronic business transaction system 100 through the bidder's terminal 300, looks into a bid announcement for the electronic businesses, and selects the electronic business. Then, the electronic business transaction system 100 provides a user interface (UI) through which the bid information for the electronic business will be input and an execution group for executing the electronic business will be organized. Here, the execution group may be organized by a recommendation of a recruiter. FIG. 4 illustrates an example of the user interface through which the bidder inputs the bid information for the electronic business, wherein the user interface is provided by the bid information input unit 140. FIG. 5 illustrates an example of the user interface through which the execution group for the electronic business is organized, wherein the user interface is provided by the bid information input unit 140.

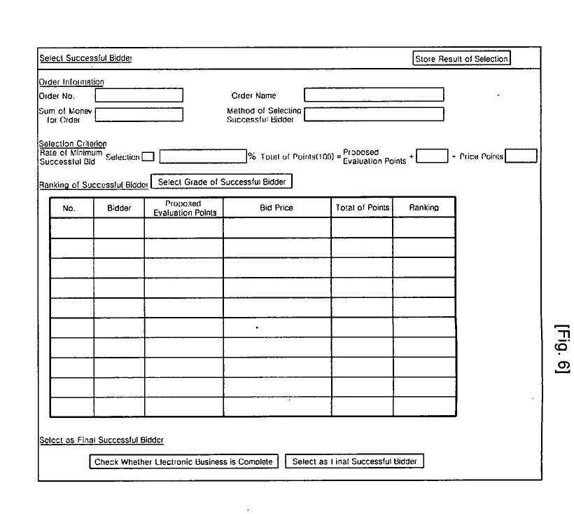

The order-taking party selecting unit 150 analyzes the information regarding the execution group and the bid information for the electronic business, thus selecting an order-taking party from among bidders for the electronic business according to the result of the analysis. In detail, the electronic business transaction system 100 selects an order-taking party from among bidders for the electronic businesses, on the basis of the result of the analysis, a grade of the execution group, etc., and announces the order-taking party or informs the order-taking party of the fact that he or she is selected as an order-taking party through an e-mail, a text message of the order-taking party's cellular phone, etc. An algorithm of selecting an order-taking party depends on items that are evaluated, and items to which weights are assigned. Such an algorithm is well-known to one of ordinary skill in the art, and accordingly, a detailed description thereof will be omitted. FIG. 6 illustrates an example of a screen on which an order-taking party is selected by the order-taking party selecting unit 150.

The electronic contract concluding unit 160 concludes an electronic contract between the ordering party and the order-taking party, and encrypts and stores an electronic contract document for the electronic contract.

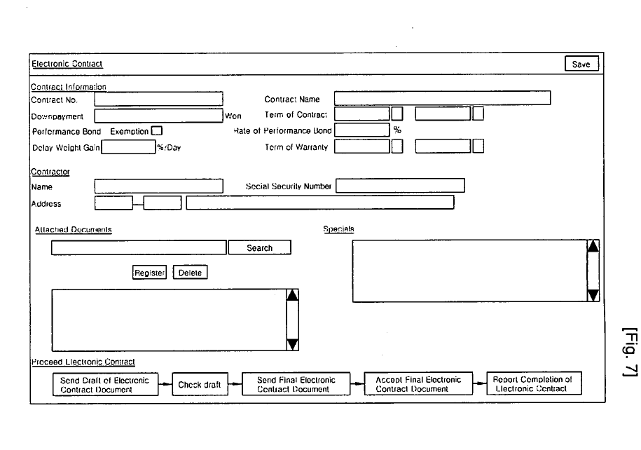

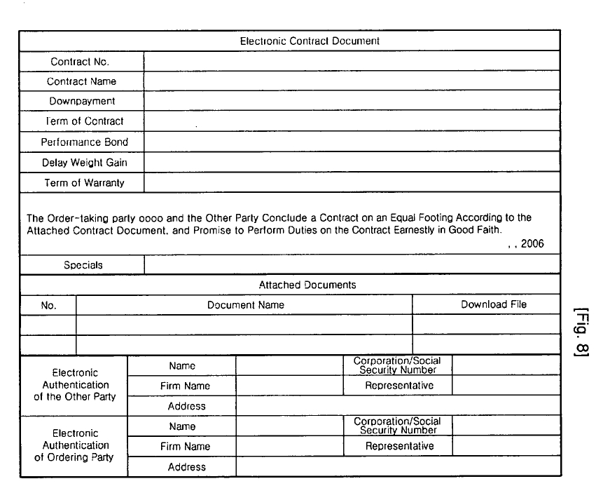

If the order-taking party is selected by the order-taking party selecting unit 150, the electronic business transaction system 100 provides to the ordering party or order-taking party a user interface for drawing up the electronic contract document as illustrated in FIG. 7 through the electronic contract concluding unit 160, receives the contents of the electronic contract document from the ordering party or order-taking party, provides the electronic contract document to the other party, concludes the electronic contract between the ordering party and the order-taking party if the electronic contract document is confirmed by the other party, for example, if the electronic contract document is authenticated by the other party, and creates an electronic contract document as illustrated in FIG. 8. Then, the electronic business transaction system 100 encrypts the electronic contract document and stores it in a database so that the electronic contract document can be used as evidence data when non-fulfillment, forgery/falsification, denial, etc. for the electronic contract occurs. The electronic contract document can be transmitted to the ordering party or order-taking party so that he or she can keep the electronic contract document. Or, the electronic contract document is used to request the ordering party or order-taking party to conclude the electronic contact or inform the ordering party or order-taking party of the fact that the conclusion of the electronic contract has been complete, through an e-mail or a text message of his or her cellular phone, etc.

The electronic business processing unit 170 provides to an execution group member's terminal 400 an application for processing the electronic business regarding the electronic contract, and processes the electronic business using the application. In detail, if the electronic contract is concluded by the electronic contract concluding unit 160, the electronic business transaction system 100 provides an application for processing the electronic business regarding the electronic contract, that is, a software module required to process the electronic business, to the execution group member's terminal 400. Here, the application may be a server-side software module which is executed in the electronic business transaction system 100, or a client-side software module which is downloaded to and executed by the execution group member's terminal 400. Also, the application may be a standard API, a common database model, or a software tool. Then, the execution group member processes the electronic business through the execution group member's terminal 400 using the application.

The payment processing unit 180 pays for the electronic business regarding the electronic contract. In detail, if an electronic contract is concluded by the electronic contract concluding unit 160, the ordering party can pay for the order-taking party in a manner to pay for the electronic business in advance before the electronic business is processed, later after the electronic business has been processed, or in lots of little amounts while the electronic business is processed, using a payment method such as an online payment service. According to a payment request of the ordering party, the electronic business transaction system 100 provides a payment interface such as an online payment service to the ordering party's terminal 200, through the payment processing unit 180, so that the ordering party pays for the electronic business regarding the electronic contract through the ordering party's terminal 200.

Here, the payment processing unit 180 transfers a sum of money for the electronic business paid by the ordering party to a virtual account of the order-taking party, and then distributes the sum of money to an actual account of each execution group member. Preferably, the payment processing unit 180 distributes a sum of money for the electronic business paid by the ordering party to an actual account of each execution group member, differentially, according to their shares which are set to the respective execution group members. The payment processing unit 180 may distribute the sum of money to the actual account of each execution group member after subtracting a commission for the electronic business transaction service from the amount of money. A virtual account can be made for each electronic contract concluded by the electronic contract concluding unit 160, or can be made not when an electronic contract is concluded but when the order-taking party becomes a member.

Meanwhile, according to the present invention, an application for defining and processing the electronic business can be created by establishment of a logic model (creating a use case model or defining classes), prototyping (establishment and verification of a prototype), designing for details (designing for a database, designing for classes, and physical packaging), and coding and test (program coding and test). Since the definition of data and the establishment of the application are well-known in development of a program for a database, and depend on the type of a program that is to be developed, a detailed description thereof will be omitted.

Accordingly, the electronic business transaction system 100 defines electronic businesses and standardizes a procedure of each electronic business through the electronic business defining unit 110, receives order information for an electronic business selected by an ordering party through the order information input unit 120, announces a bid for the electronic business through the electronic business bid announcement unit 1230, allows bidders to input bid information for the electronic business and organize execution groups for the electronic business through the bid information input unit 140, analyzes the bid information and information for the execution groups through the order-taking party selecting unit 150 to select an order-taking party from among the bidders, concludes an electronic contract between the order-taking party and the ordering party through the electronic contract concluding unit 160, provides to an execution group member's terminal an application for processing the electronic business regarding the electronic contract, allows the execution group member's terminal to process the electronic business through the electronic business processing unit 170, and pays for the electronic business regarding the electronic contract through the payment processing unit 180. Therefore, the electronic business transaction system 100 transacts a standardized electronic business in an online environment by organizing an execution group, electronically contracting the electronic business, and distributing the electronic business to members belonging to the execution group in the online environment, thereby assigning a value to labor and transacting the labor as a type of electronic goods.

Meanwhile, according to another embodiment of the present invention, the electronic business transaction system 100 can further include a mutual evaluation unit 190. The mutual evaluation unit 190 mutually evaluates the ordering party, order-taking party, and execution group members who participate in the electronic business which has been completely processed, and reflects the results of the mutual evaluation in grades of the corresponding ordering party, order-taking party, and execution group member. That is, according to the current embodiment of the present invention, after the electronic business is completely processed, the ordering party evaluates the performance capabilities, credits, etc. of the order-taking party and execution group members. The order-taking party and the execution group members also evaluate the credits, etc. of the ordering party. Provided grades of the ordering party, order-taking party, and the each execution group member, other bidders can refer to the grade of the ordering party when they enter a bid for an electronic business, organize an execution group for the electronic business, or join the execution group, thereby providing a more reliable service. The electronic business transaction system 100 provides a user interface for providing questions and collecting answers required to evaluate the other party, to terminals of participants (the ordering party, order-taking party, execution group members, and recruiter) of the electronic business which has been completely processed, through the mutual evaluation unit 190. The electronic business transaction system 100 evaluates the participants on the basis of question/answer data which is input by the participants, calculates the grades of the participants, and stores the results of the calculation in a database. Here, different weights can be assigned to respective question items. Since a technique of calculating grades using question/answer data is well-known in the art, a detailed description thereof will be omitted.

Meanwhile, according to another embodiment of the present invention, the electronic business transaction system 100 can further include a result data receiving unit 192 and a result data examination unit 194. The result data receiving unit 192 receives final result data of the electronic business from the order-taking party's terminal or from the execution group members' terminals. The result data examination unit 194 examines the final result data of the electronic business. That is, the result data receiving unit 192 and the result data examination unit 194 are used to determine whether the electronic business processed by the execution group member has been correctly processed, request correction if an error exists in processing of the electronic business, and confirm the processing completion of the electronic business if no error exists in processing of the electronic business. In detail, if final result data of the electronic businesses is transferred from the order-taking party's terminal or from the execution group member's terminal 400, the result data receiver 192 receives the final result data, and the result data examination unit 194 examines the final result data. An algorithm for examining data is well-known in the art, and accordingly, a detailed description thereof will be omitted.

Meanwhile, according to another embodiment of the present invention, the electronic business transaction system 100 can further include an electronic business progression reporting unit 196. The electronic business progression reporting unit 196 reports the progression status of the electronic business to the ordering party's terminal which has ordered the electronic business. The electronic business transaction system 100 allows the ordering party to know the progression status of the electronic business periodically or non-periodically. In detail, the electronic business transaction system 100 allows the order-taking party or execution group members to report the progression status of the electronic business processed by the execution group members periodically or non-periodically to the ordering party through the electronic business progression reporting unit 196 so that the ordering party can know the progression status of the electronic business.

Meanwhile, according to another embodiment of the present invention, the electronic business transaction system 100 can further include a member management unit 198 and a member authentication unit 199. The member management unit 198 provides a user interface through which member information is input. The member management unit 198 receives member information through the user interface, performs member registration, and stores the member information in a database. The member authentication unit 199 processes member authentication for the ordering party, order-taking party, and execution group members who participate in electronic business transactions, with reference to the member information stored in the database. A member who wants to use an electronic business transaction service according to the present invention can be registered to at least one of an ordering party, an order-taking party, and an execution group member, and a recruiter qualification for recommending an execution group member can be given through qualification inspection to one or more among registered members. The electronic business transaction system 100 may provide the electronic business transaction service as a closed user service. A member registration and authentication technique is well-known in the art before this application is filed, and accordingly, a detailed description thereof will be omitted.

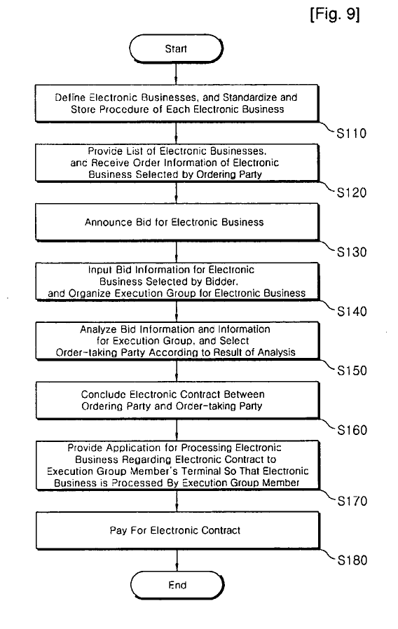

Now, an electronic business transaction method, which is performed by the electronic business transaction system 100 according to the present invention, will be described with reference to FIG. 9.

Referring to FIGS. 1 and 9, in operation S110, the electronic business transaction system 100 defines electronic businesses, categorizes the electronic businesses according to the types and fields of the electronic businesses, and standardizes and stores a procedure of each electronic business through the electronic business defining unit 110. Then, in operation S120, the electronic business transaction system 100 provides a list of the electronic businesses, and receives order information for an electronic business selected by an ordering party through the order information input unit 120.

Then, in operation S130, the electronic business transaction system 100 announces a bid for the electronic business through the electronic business bid announcement unit 130. Then, if bidders who want to enter the bid for the electronic business select the electronic business, in operation S140, the electronic business transaction system 100 receives bid information for the electronic business and information regarding execution groups of the electronic business from the bidders, through the bid information input unit 140. Then, in operation S150, the electronic business transaction system 100 analyzes the bid information for the electronic business and the information regarding the execution groups, and selects an order-taking party from among the bidders according to the results of the analysis, through the order-taking party selecting unit 150.

Then, in operation S160, the electronic business transaction system 100 concludes an electronic contract between the ordering party and the order-taking party, through the electronic contract concluding unit 160. Next, in operation S170, an application for processing the electronic business regarding the electronic contract is provided to terminals of execution group members belonging to the execution group of the order-taking party so that the electronic business is processed by the execution group members. In operation S180, the electronic business transaction system 100 pays for the electronic business regarding the electronic contract through the payment processing unit 180. Therefore, according to the present invention, it is possible to transact an electronically contracted electronic business in an online environment by organizing an execution group for the electronic business and distributing the electronic business to members belonging to the execution group in the online environment, thereby assigning a value to labor and transacting the labor as a type of electronic goods.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be applied to a technical field for electronic business transactions between an ordering party and an order-taking party in an online environment.

1. An electronic business transaction system comprising: an electronic business defining unit defining a plurality of electronic businesses, categorizing the electronic businesses according to types or fields of the electronic businesses, standardizing a procedure of each electronic business, and storing the procedure of the each electronic business; an order information input unit providing a list of the electronic businesses, requesting an ordering party to select an electronic business from among the electronic businesses and input order information for the electronic business through a terminal of the ordering party; an electronic business bid announcement unit announcing a bid for the electronic business; a bid information input unit requesting bidders for the electronic business to select the electronic business, and input bid information for the electronic business, and execution groups organized to execute the electronic business, through terminals of the bidders; an order-taking party selecting unit analyzing the bid information for the electronic business and information for the execution groups of the bidders that are input through the bid information input unit, and selecting an order-taking party from the bidders according to the result of the analysis; an electronic contract concluding unit concluding an electronic contract for the electronic business between the ordering party and the order-taking party, and encrypting and storing an electronic contract document for the electronic contract; an electronic business processing unit providing an application for processing the electronic business to terminals of execution group members belonging to an execution group of the order-taking party, and allowing the terminals of the execution group members to process the electronic business; and a payment processing unit paying for the electronic business regarding the electronic contract.

2. The electronic business transaction system of claim 1, wherein the payment processing unit receives a sum of money for the electronic business paid by the ordering party through a virtual account of the order-taking party, and distributing the sum of money to an actual account of each execution group member belonging to the execution group.

3. The electronic business transaction system of claim 2, wherein the payment processing unit distributes the sum of money to the actual account of the each execution group member, differentially, according to their shares which are set to the respective execution group members.

4. The electronic business transaction system of claim 1, further comprising a mutual evaluation unit mutually evaluating the ordering party, the order-taking party, and the execution group members who participate in the electronic business electronically contracted, and reflecting the result of the mutual evaluation in grades of the ordering party, the order-taking party, and the execution group members.

5. The electronic business transaction system of claim 4, further comprising: a result data receiving unit receiving final result data of the electronic business from the terminal of the order-taking party or from the terminals of the execution group members; and a result data examination unit examining the final result data of the electronic business.

6. The electronic business transaction system of claim 5, further comprising an electronic business progression reporting unit reporting a progression status of the electronic business to the terminal of the ordering party who has ordered the electronic business.

7. The electronic business transaction system of claim 6, further comprising: a member management unit providing a user interface through which member information is input, receiving the member information through the user interface, performing member registration, and storing the member information in a database; and a member authentication unit performing member authentication for the ordering party, the order-taking party, and the execution group members who participate in the electronic business, with reference to the member information stored in the database.
